(19) United States
(12) Patent Application Publication
(10) Pub. No.: US 2012/0036252 A1
(43) Pub. Date: Feb. 9, 2012

(54) OSGI-BASED HETEROGENEOUS SERVICE INTEGRATING SYSTEM AND METHOD

(75) Inventors: Dianxi Shi, Changsha City (CN); Wei Zhang, Changsha City (CN); Huaimin Wang, Changsha City (CN); Bo Ding, Changsha City (CN); Hui Liu, Changsha City (CN); Gang Yin, Changsha City (CN); Meng Teng, Changsha City (CN); Yongzhi Yang, Changsha City (CN); Xiang Rao, Changsha City (CN)

(73) Assignee: National University of Defense Technology of the Chinese People's Liberation Army, Changsha City (CN)

(21) Appl. No.: 12/967,614

(22) Filed: Dec. 14, 2010

(30) Foreign Application Priority Data
Aug. 5, 2010 (CN) CN201010251926.X

(51) Int. Cl. G06F 15/173

(52) U.S. Cl. 709/224

(57) ABSTRACT

The present invention provides an OSGi-based heterogeneous service integrating system comprising a Java virtual machine and an OSGi container, the system further comprises a service management module, a handler management module, a monitor module, a service discovery module and a handler module that are running on said OSGi container, wherein: said service management module is adapted to monitor requests for registering and using of a remote service, to manage different types of services, and to notify said handler management module to make corresponding publishing and calling for different service configuration types; said handler management module is adapted to manage said handler module and to publish service to and call service from remote end points, and to call the corresponding handler module based on information delivered by the service management module, and to maintain information of currently published services and adopted remote services; said monitor module is adapted to monitor a local service registry in said OSGi container and to obtain information to be monitored from the service management module; said service discovery module is adapted to make remote service discovery; and said handler module is adapted to realize access of a module within the OSGi container to a service outside the OSGi container.

### TECHNICAL FIELD

The present invention relates to the field of network transmission, in particular to an OSGi-based heterogeneous service integrating system and method.

### BACKGROUND ART

As one of the greatest inventions in human history, computers replace manual labor to process a large amount of repetitive work. Computers are especially useful in industrial applications, playing various roles in strategy decision, production, sales and after-sales service, reducing the cost while greatly improving the production efficiency. For this purpose, various enterprises and institutions put a big investment to develop various information systems to be used with their respective fields of interest so as to help them to perform internal or external business processing and management. Due to the difference in the fields of interest, there is no universal interface standard and specification for the various systems. Even in the same enterprise, respective functional departments act on their own free will, as a result, a lot of key information is blocked in mutually isolated systems and so-called “information silo” is then formed one by one, resulting in decrease in the enterprise work efficiency and increase in the operation cost.

With the expansion of enterprises and the acquisition and bankruptcy of enterprises under market rules, the original information system will have to change inevitably. It is imperative to adapt to such changes and to associate numerous “information silos” to exchange information between different systems. The heterogeneous service integrating technology designed for solving this problem attracts wide attention.

Traditional heterogeneous service integrating technology usually adopts specific component and distribution technique, such as CORBA (Common Object Request Broker Architecture), COM/DCOM, RMI, and so on. The use of the above techniques has solved the problem of integration to some extent. However, there are still some problems. On the one hand, the system architecture will become more complicated and the invasion on the original systems is dramatic. On the other hand, different technique architectures are mutually independent. Although there are various bridging techniques, these techniques themselves are only designed for some particular technical architectures, which means an upper-level problem regarding application integration of different technique architectures still exists.

Considering that the traditional heterogeneous service integrating technique has the aforesaid drawbacks, those skilled in the art propose a Service Oriented Architecture (SOA), which integrates well-established interfaces and standards between various functional components (also referred to as service) of the applications on the heterogeneous platform in a loosely coupled manner. Based on the concept of the SOA, those skilled in the art further propose for JAVA a dynamic and modularized architecture model called OSGi (Open Service Gateway initiative).

In OSGi, a module running on the kernel of OSGi is called as a bundle, which consists of a common JAR file and additional meta-information description. The sharing of codes and resources between the bundles is realized through meta-information description explicitly announcing the import and export of packages, while the kernel of OSGi automatically processes the dependency resolving between bundles. Meanwhile, the OSGi provides a service-oriented programming module as well, which in OSGi is a normal Java object. A bundle may register service via a service registry, while other bundles can inquiry, monitor and acquire service via the service registry so as to realize the loose coupling coordination between the bundles. The contract of service is described by Java interface and a series of service attributes.

In recent years, with more and more large-scale applications employing the OSGi technique, especially after Eclipse Version 3.0 used the OSGi to refactor its architecture, the OSGi gets more and more extensive application in the area of enterprise computing. For example, WebSphere of IBM and WebLogic of Oracle/BEA both adopt the OSGi technique. Although the implementation of the cross virtual machine is defined in the OSGi, a certain kind of specific interoperation mechanism is likewise adopted for specific realization, thus spoiling the possibility of interoperation between OSGi containers that are based on different remote access methods.

### SUMMARY OF THE INVENTION

An object of the invention is to overcome limitations brought by the prior art heterogeneous service integrating system due to the adoption of a specific inter-operation mechanism, thereby providing a heterogeneous service integrating system with a wide application range.

In order to realize the above object, the present invention provides an OSGi-based heterogeneous service integrating system comprising a Java virtual machine and an OSGi container, the system further comprises a service management module, a handler management module, a monitor module, a service discovery module and a handler module running on said OSGi container, wherein:

said service management module is adapted to monitor requests for registering and using of a remote service, to manage different types of services, and to notify said handler management module to make corresponding publishing and calling with respect to different service configuration types; said handler management module is adapted to manage said handler module and to publish service to and call service from a remote endpoint, and to call the corresponding handler module based on information delivered by the service management module, and maintain information of currently published services and invoked remote services; said monitor module is adapted to monitor a local service registry in said OSGi container and to obtain information to be monitored from the service management module; said service discovery module is adapted to make remote service discovery; and said handler module is adapted to realize access of a module within the OSGi container to a service outside the OSGi container.

In the above technical solution, said handler module comprises a web service handler module, a CORBA handler module and an SCA handler module.

In the above technical solution, said web service handler module uses Axis as an underlying inter-operation component.

In the above technical solution, said CORBA handler module uses JacORB as an underlying inter-operation component.

In the above technical solution, said SCA handler module uses Apache Tuscany as an underlying inter-operation component.

In the above technical solution, said service discovery module comprises a service discovery method for discovering a type of remote service; the type of said service discovering method is related to the type of the heterogeneous service integrated by the system.

In the above technical solution, said service discovery method includes: UDDI, naming service mechanism of CORBA, service discovery mechanism of SLP and local configuration file.

In the above technical solution, said handler management module abstracts the underlying remote inter-operation function of said handler module to realize publishing of services to and calling of services from the remote end points with a universal interface.

In the above technical solution, said information to be monitored includes: adopted remote services, exposed services, dependency of packages, number of threads and usage of native stack.

The present invention further provides a method for the OSGi-based heterogeneous service integrating system, comprising:

step 1): registering, by a service that can be accessed remotely, on a local service registry of a node where the service is hosted;
step 2): publishing said service that can be accessed remotely to a remote node according to a type of configuration;
step 3): enquiring, by a service consumer on the remote node, to a service registry on the remote node for the service to be accessed; and
step 4): when the service to be accessed does not exist locally in the remote node, making, by said remote node, remote service discovery, via a service discovery module, and starting a corresponding handler module according to the type of configuration to complete service calling.

In the above technical solution, said step 2) includes:

step 2-1): after a registration event is detected through monitoring, acquiring, by the service management module on the node where the service is hosted, description information of the service and notifying the service discovery module to create a service description instance;
step 2-2): registering, by said service discovery module, the service onto the remote service registry;
step 2-3): creating, by said handler management module, a corresponding handler module according to the type of configuration; and
step 2-4): publishing, by said handler module, said service according to the service description instance.

In the above technical solution, said step 4) includes:

Step 4-1): inquiring, by said service management module on the remote node, on which node the required service is present via the service discovery module on the remote node;
Step 4-2): generating, by said service discovery module on the remote node, a service description instance according to a result of inquiry;
Step 4-3): creating, by said handler management module on the remote node, a corresponding handler module according to the type of configuration; and
Step 4-4): completing, by said handler module, service calling using the service description instance.

The advantage of the invention lies in that:

the present invention is widely applicable and flexible.

### DESCRIPTION OF THE DRAWINGS

FIG. 1 is an overall block diagram of an OSGi-based heterogeneous service integrating system according to the present invention;

FIG. 2 is a diagram of a typical application scenario of the OSGi-based heterogeneous service integrating system of the present invention;

FIG. 3 is a schematic diagram illustrating the service publishing process of an OSGi-based heterogeneous service integrating method of the present invention; and

FIG. 4 is a schematic diagram illustrating the process of service seeking and calling of the OSGi-based heterogeneous service integrating method of the present invention.

### DETAILED EMBODIMENTS

The present invention will be described in detail in combination with the following embodiments and drawings.

FIG. 1 shows an overall structure of the OSGi-based heterogeneous service integrating system of the present invention. It can be seen from this figure that the system comprises a JVM (Java Virtual Machine), an OSGi container, a service management module, a handler management module, a monitor module, a service discovery module and handler modules. The function of each of the aforesaid modules will be explained below.

The JVM is a runtime environment of the programming language Java. The OSGi container is, in essence, a dynamic and modularized system provided for Java which is able to manage the modules (i.e. Bundles) running therein. The realization of said JVM and OSGi container is well-know in the art and will not be described in details here. Said service management module, handler management module, monitor module, service discovery module and handler modules are all running on the basis of the OSGi container.

Said service management module is responsible for monitoring requests for registering and using the remote service. When the system is loaded, this module needs to register the monitoring service on the local service registry in the OSGi container. The registered monitoring service is implemented in different ways with regard to the requests for registering and using of the remote service, which will be described in further detail in the following.

For remote service registration, when executing the registration process, the OSGi kernel will generate a service registration event, while the service management module uses a ServiceListener class as provided by the OSGi kernel to receive the service registration event sent from the OSGi kernel, and acquires the attribute information of the registration service via the context provided by the OSGi kernel. Said attribute information is presented in the form of character string and is written into the local service registry during service registration. For example, attribute information containing the field “Remote” represents that the service having this attribute is desired to be published for remote use, and the attribute information containing the field “Type” indicates the publishing type information of the service having this attribute. For example, “CORBA”, “Web” and “SCA” all indicate the modes adopted during service publication. Specifically, “#” is used to indicate that all supported types will be used for publishing. If attribute information contains the field “Method”, it indicates the method name in the service object that needs to be published. “*” is the default value, i.e. all methods. After finishing the aforesaid remote service registration, the service management module will notify the handler management module to publish the service.

As for the request for using service, the service management module uses the ListenerHOOK class provided by the kernel of OSGi. Such a class comprises three callback functions which are used to handle the following three situations respectively: (1) what to do when the required service is coming; (2) what to do when the required service is cancelled; and (3) what to do when the required service has a change (for example, a change in the service attribute). In the meantime, the ListenerHOOK class further comprises a private class of the Listenerinfo class. Where there is a request for using the service, the Listenerinfo class will be instantiated as specific request information (including service interface name, the name of the called function, the adopted communication method, etc.). The service management module obtains the request information and describes the service to be used via a character string and notifies the service discovery module to make service discovery.

In addition, the service management module contains the data structure of a list wherein the information of remote service that is already published and is being called is recorded; thereby different types of services can be managed. The service management module and the modules mentioned below can be realized by the Bundle module in the OSGi.

The handler management module is used to manage different handler modules comprising the creation, initialization, and cancellation of different handler modules. An interface class called Handler is defined in the handler management module, while a private attribute of the Endpointdescription class (an end point description instance including the service description information such as service ID, frame UUID, interface name, service publishing method) and two abstract methods, i.e. Export( ) and Import( ), are defined in this interface. The handler modules derived from said module need to realize said interface class and the attribute and methods thereof. Thereby the underlying remote inter-operation function of the handler modules is generalized such that the handler modules can publish service to the remote end points using a universal interface and to call service from the remote end points. In the embodiment, the handler management module can be realized using the factory pattern of the software engineering, which facilitates to improve the expansibility of the handler management module.

The handler management module communicates with the service management module via the method provided by the RSAListener class supplied by the OSGi specification, so that the handler management module can obtain the configuration type and service description information delivered from the service management module and then call the corresponding handler module to do the handling. The handler management module may further maintain the currently published services and the currently adopted remote services, together with the information such as failure of creation, deletion and calling of the service, and notify the service management module as well. In this way the service management module gets to know the current situation and maintain the aforesaid linked list.

The monitor module is responsible for using the aforesaid monitor service to monitor the local service registry within the OSGi container. In the meantime, the monitor module uses the EndpointListener class (the class includes the attribute of a service reference type and the methods like EndpointAdded( ), EndpointRemoved( ), Export( ), Import( ), getEndpoint( ), which are used to control the increase and decrease of end point description instances during the process of service publishing and service calling, respectively) provided by the OSGi standard, and the relevant information of remote service is obtained from the service management module. The information mainly includes: the adopted remote services, the exposed services and the dependency of packages. Besides, the number of the local threads is obtained based on the Thread.currentThread( ) and getThreadGroup methods provided by Java language, and the usage of local stacks is obtained using the methods like java.lang.Runtime.totalMemory( ) and java.lang.Runtime.freeMemory( ) and the customized algorithm. The aforesaid information and runtime situation will be presented in a visual form. In addition, this module needs to evaluate the runtime state of the system according to the monitored information so as to change the runtime behavior of the system on its own initiative, according to the related mechanism such as java.lang.Runtime.gc( ) function provided by Java language and a series of console commands regarding the management of Bundle life circle provided by the OSGi kernel. As a result the system is able to run for a long time at a good state under as little human intervention as possible.

The service discovery module is responsible for remote service discovery. Similar to the handler management module, the service discovery module comprises an interface class of Discovery, which contains the private attribute of a ServiceReference type (service reference, which can be interpreted as the name of a specific service object) for recording the service description information delivered from the service management module. This class further includes three abstract methods, i.e., Export( ), Search( ) and GenerateEndpoint( ), which correspond to service publishing, service enquiry process and the method for generating EndpointDescription instances respectively. In this embodiment, various service discovery methods such as the naming service mechanism of UDDI and CORBA, the service discovery mechanism of SLP and the local configuration file are created within this module. Each method implements the aforesaid Discovery interface, in the meantime, the service discovery type that needs to be loaded may be configured prior to system running. The service discovery module uses EndpointListener class to interact with the service management module. The service discovery module handles the service issuance process and the service calling process in different ways which are described specifically as follows.

As for the service publishing process, after said service management module detects a service publishing event through monitoring, the service discovery module will receive the parameters of ServiceReference type delivered from the service management module, and then call the GenerateEndpoint( ) method to generate an EndpointDescription instance and deliver it to the service management module. According to the above configured service discovery type that is loaded, said example is written into the local file or registered with the remote service registry.

As for the service calling process, after said service management module detects the remote service calling request through monitoring, if the requested service attribute contains the field “configfile”, the service discovery module reads information of the configured file from the default local position. The configured file is usually an Xml file wherein the information of remote service, including address, the exposed class name, method name, etc., is described using standard xml grammar. If the aforesaid field “configfile” is not contained, the configured service discovery method is initiated to search in the remoteservice registry, and the GenerateEndpoint( ) method is finally called to generate EndpointDescription instances which are delivered to the service management module.

The handler module finishes the accessing process of the modules within the OSGi container to the service outside the OSGi container based on the existing remote inter-operation realization mechanism (such as CORBA, WebService, etc.). The handler module has many types according to the service types and in this embodiment it includes a web service handler module, a CORBA handler module and an SCA handler module. The type of the handler module may be flexibly increased or decreased as required.

All types of handler modules are generated by the handler management module. All handlers will have some common attributes and methods because each of them realizes the aforesaid Handler interface class. These common methods can be used to process service publishing and service calling of different configuration types respectively. In each type of handler module, corresponding run-time components are established. For example: CORBA handler module uses JacORB (an open source code CORBA product, designed to support Java language mapping and satisfies CORBA2.3 standard and provides a wide platform support) as an underlying inter-operation component of CORBA configuration type service. Similarly, the Web service handler module and SCA handler module respectively use Axis (Apache Extensible Interaction System, an open source project under Apache organization for developing webservice) and Apache Tuscany (an open source project for supplying an SOA infrastructure and SCA run-time environment, the Tuscany project itself does not supply SOA development and management IDE plug-in unit) as an underlying inter-operation component of the corresponding configuration type service.

At a specific handler-creating stage, the private attribute of the aforesaid EndpointDescription class will use the EndpointDescription instance obtained by the service management module from the service discovery module for initialization. Meanwhile, the run-time component adopted by the handler will do some initialization work with regard to its specific program model, such as the loading of class library and the establishment of communication protocol. In CORBA, it corresponds to initializing ORB and POA; as for WebService, it corresponds to initializing Axis engine; as for SCA, it corresponds to initializing Tuscany, and instantiating SCADomain. At the runtime stage, the export( ) and import( )methods of a specific handler will be called to perform service publishing and calling. At the cancellation stage, the destructor function of each handler will be called to finish resource release. Please note that the above operations during initialization process, runtime period and cancellation shall follow their own programming models depending on the specific handler. Said programming models are commonly known and will not be described in detail here.

All function modules in the OSGi-based heterogeneous service integrating system of the present invention are described above. In the following, remote service registration, and search and use of remote service of the present invention will be described respectively in combination with these modules.

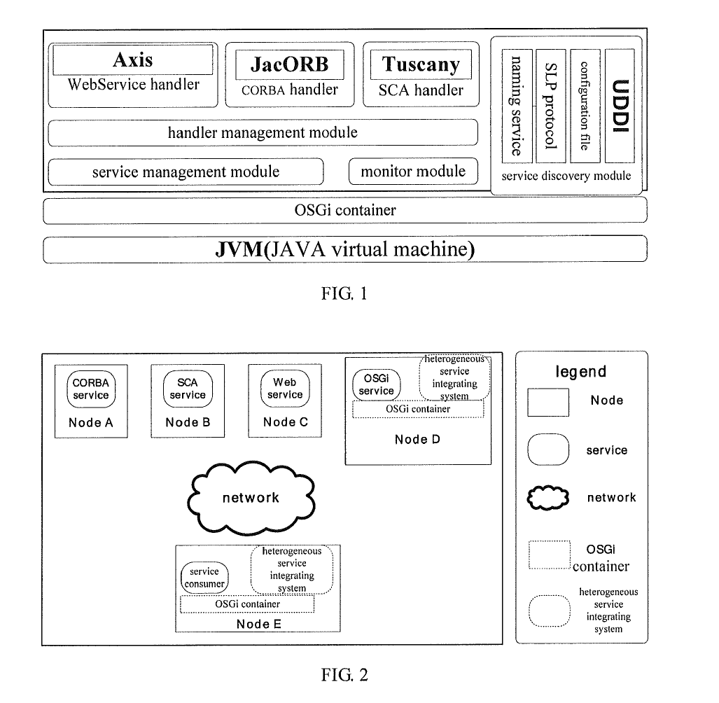

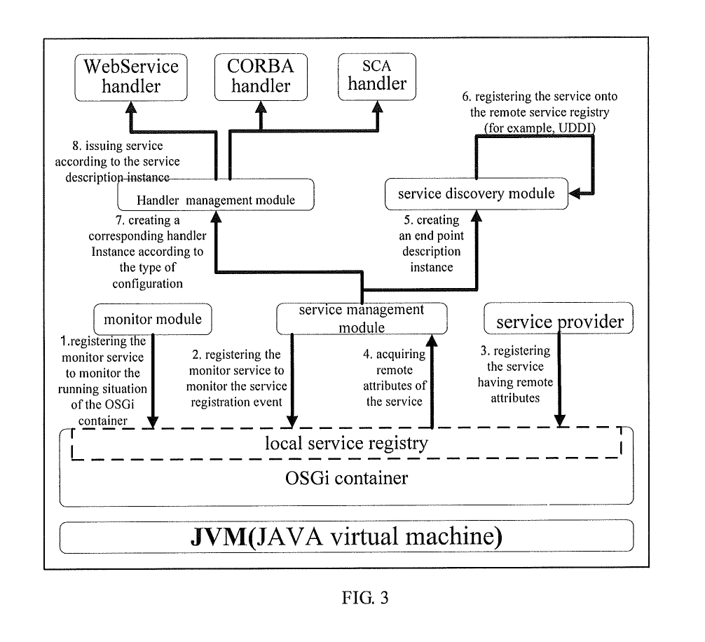

To facilitate understanding of the invention, a typical application scenario of the present invention is shown in FIG. 2. This scenario has five nodes A, B, C, D and E, in which node A provides CORBA service, node B provides SCA service, node C provides Web service, node D provides OSGi service running in the OSGi container, and node E is the service consumer running within the OSGi container.

The registration process of the remote service is described in combination with FIG. 3. The OSGi local service within node D needs to be published to remote nodes A, B, C and E. Prior to publishing the local service to the remote nodes, first of all, it needs to perform basic registration operation. The registration operation includes the following steps: the monitor module on node D registers with the local service registry within the OSGi container located on this node for monitor service, then said monitor module monitors the runtime situation of the OSGi container; after that, the service management module registers with the local service registry for monitor service (the monitor service registered by the service management module is different from the monitor service registered by the monitor module) to monitor the service registration event. Said registration operation is not merely required for the registration process of remote service, similar registration operation also needs to be accomplished prior to the search and using of the remote service.

After finishing the above registration operation, the service provider (i.e. OSGi local service within node D) registers with said local service registry. This service has remote attribute because it will be published to remote nodes A, B, C and E. Next, the service management module acquires from the local service registry the remote attribute of the service to be published, and transmits the acquired remote attribute to the service discovery module. Then the service discovery module creates an end point description instance according to the remote attribute information of the service. Said end point description instance contains the service description information such as the attribute of service, service ID, frame ID and so on. Said service discovery module registers the service to be published onto, for example, the name server of CORBA or the remote service registry of UDDI, according to the information in the end point description instance. Finally, said handler management module will, according to said remote attribute and the configuration type information (such as the combination of one or more of CORBA, Web and SCA) identified when the service provider registers with the local service registry for services, create a corresponding handler module. Said handler module publishes services according to the service description instance.

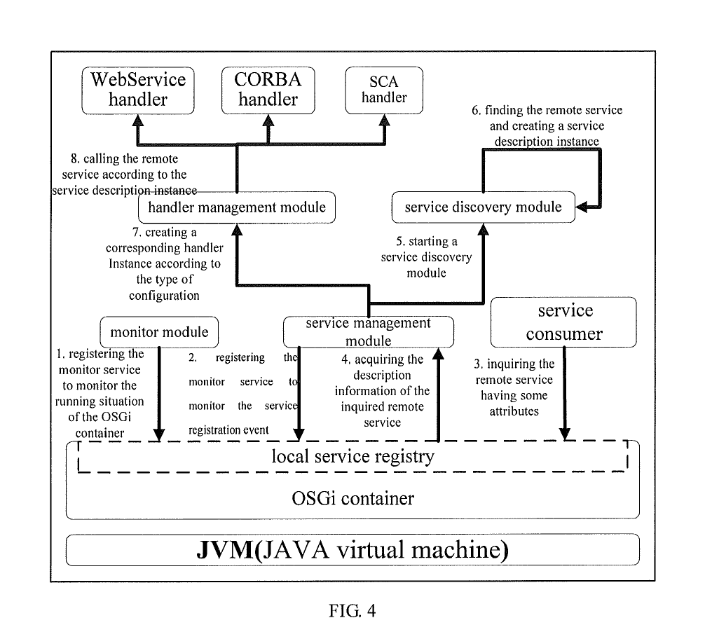

Above is a description of the remote service registration process. The process of the searching and using of the remote service will be described below in combination with FIG. 4.

After finishing the basic registration operation, when the local OSGi Bundle (i.e. service consumer) of node E calls the remote service, the searching is first performed within the local service registry on node E. If the local service registry finds that the required service has remote attribute, it will notify the service management module to initiate the service discovery module on node E. This service discovery module uses the corresponding service discovery manner to search in the remote center and to generate a service description instance according to the search result. After obtaining the service description instance, the service management module notifies the handler management module to derive the corresponding handler module according to the service description information and configuration type information (such as the combination of one or more of CORBA, Web, SCA) in the service description instance, to create a proxy for remote service and to register said proxy as local service. As a result, the service consumer will call the remote service like using the local service.

The heterogeneous service integrating system of the invention and the related integrating process are described above. The present invention is widely adaptive and flexible because it generalizes the underlying remote inter-operation function common to different types of handler modules to form an independent handler management module, such that different handler modules are able to publish services to remote end point with a universal interface and to call services from the remote end point, thereby overcoming the defect of narrow range of application brought by the specific inter-operation mechanism adopted by the existing heterogeneous service system.

Finally, it is noted that the above embodiments are only used to explain the technical solution of the present invention and shall not be construed as limitation. Although the invention is described specifically with reference to its embodiments, those ordinarily skilled in the art shall understand that any modification to the technical solution or equivalent replacement shall be covered in the scope defined in the appended claims without departing from the spirit and scope of the technical solution of the invention.

1. An OSGi-based heterogeneous service integrating system, comprising a Java virtual machine and an OSGi container, characterized in that the system further comprises a service management module, a handler management module, a monitor module, a service discovery module and a handler module that are running on said OSGi container, wherein: said service management module is adapted to monitor requests for registering and using of a remote service, to manage different types of services, and to notify said handler management module to make corresponding publishing and calling with respect to different service configuration types; said handler management module is adapted to manage said handler module and to publish service to and call service from remote end points, and to call the corresponding handler module based on information delivered by the service management module, and to maintain information of currently published services and adopted remote services; said monitor module is adapted to monitor a local service registry in said OSGi container and to obtain information to be monitored from the service management module; said service discovery module is adapted to make remote service discovery; and said handler module is adapted to realize access of a module within the OSGi container to a service outside the OSGi container.

2. The OSGi-based heterogeneous service integrating system of claim 1, characterized in that said handler module comprises a Web service handler module, a CORBA handler module and an SCA handler module.

3. The OSGi-based heterogeneous, service integrating system of claim 2, characterized in that said web service handler module uses Axis as an underlying inter-operation component.

4. The OSGi-based heterogeneous service integrating system of claim 2, characterized in that said CORBA handler module uses JacORB as an underlying inter-operation component.

5. The OSGi-based heterogeneous service integrating system of claim 2, characterized in that said SCA handler module uses Apache Tuscany as an underlying inter-operation component.

6. The OSGi-based heterogeneous service integrating system of claim 2, characterized in that said service discovery module comprises a service discovery mode for discovering a type of remote service; the type of said service discovery mode is related to the type of the heterogeneous service integrated by the system.

7. The OSGi-based heterogeneous service integrating system of claim 6, characterized in that said service discovery method includes: UDDI, naming service mechanism of CORBA, service discovery mechanism of SLP and local configuration file.

8. The OSGi-based heterogeneous service integrating system of claim 1 characterized in that said handler management module generalizes the underlying remote inter-operation function of said handler module to realize publishing of services to and calling of services from the remote end point with a universal interface.

9. The OSGi-based heterogeneous service integrating system of claim 1 characterized in that said information to be monitored includes: an adopted remote service, an exposed service, dependency of packages and usage of local threads and stacks.

10. A method for operating the OSGi-based heterogeneous service integrating system of claim 1 comprising:
step 1): registering, by a service that can be accessed remotely, on a local service registry of a node where the service is hosted;
step 2): publishing said service that can be accessed remotely to a remote node according to a type of configuration;
step 3): enquiring, by a service consumer on the remote node, to a service registry on the remote node for the service to be accessed; and
step 4): when the service to be accessed does not exist locally in the remote node, making, by said remote node, remote service discovery via a service discovery module, and starting a corresponding handler module according to the type of configuration to complete service calling.

11. The method as of claim 10, characterized in that said step 2) comprises:
step 2-1): acquiring, by the service management module on the node where the service is hosted, description information of the service and notifying the service discovery module to create a service description instance, after a registration event is detected by monitoring;
step 2-2): registering, by said service discovery module, the service onto the remote service registry;
step 2-3): creating, by said handler management module, a corresponding handler module according to the type of configuration; and
step 2-4): publishing, by said handler module, said service according to the service description instance.

12. The method as of claim 10, characterized in that said step 4) comprises:
Step 4-1): inquiring, by said service management module on the remote node, on which node the required service is present via the service discovery module on the remote node;
Step 4-2): generating, by said service discovery module on the remote node, a service description instance according to a result of inquiry;
Step 4-3): creating, by said handler management module on the remote node, a corresponding handler module according to the type of configuration; and
Step 4-4): completing, by said handler module, service calling using the service description instance.

13. The OS Gi-based heterogeneous service integrating system of claim 2 characterized in that said handler management module generalizes the underlying remote inter-operation function of said handler module to realize publishing of services to and calling of services from the remote end point with a universal interface.

14. The OSGi-based heterogeneous service integrating system of claim 2 characterized in that said information to be monitored includes: an adopted remote service, an exposed service, dependency of packages and usage of local threads and stacks.

15. The method of claim 10 wherein the OSGi-based heterogeneous service integrating system of claim 1 is further characterized in that said handler management module generalizes the underlying remote inter-operation function of said handler module to realize publishing of services to and calling of services from the remote end point with a universal interface.

16. The method of claim 10 wherein the OSGi-based heterogeneous service integrating system of claim 1 is further characterized in that said information to be monitored includes: an adopted remote service, an exposed service, dependency of packages and usage of local threads and stacks.
